(19) United States
(12) Patent Application Publication
(10) Pub. No.: US 2015/0182033 A1
(43) Pub. Date: Jul. 2, 2015

(54) INFLATABLE AIR MATTRESS WITH INTEGRATED CONTROL

(71) Applicant: Select Comfort Corporation, Minneapolis, MN (US)

(72) Inventors: Aran Brosnan, Minneapolis, MN (US); Yi-ching Chen, Maple Grove, MN (US); John McGuire, New Hope, MN (US)

(21) Appl. No.: 14/586,694

(22) Filed: Dec. 30, 2014

Related U.S. Application Data
(60) Provisional application No. 61/921,615, filed on Dec. 30, 2013.

(51) Int. Cl. A47C 27/08; G05B 15/02; H04W 4/00; F04D 27/00

(52) U.S. Cl. CPC A47C 27/082; F04D 27/007; G05B 15/02; H04W 4/005

(57) ABSTRACT

An air bed system including a plurality of peripheral devices and a pump unit configured to adjust a firmness of an air mattress, the pump unit including a pump. The system further includes a controller configured to execute instructions that cause the pump unit to wirelessly pair with at least one of the plurality of peripheral devices. The pump unit is configured to receive at least one control signal addressed to the at least one of the plurality of peripheral devices, and transmit the at least one control signal to the addressed device.

### CROSS REFERENCE TO RELATED APPLICATION

This application claims benefit of U.S. Provisional Application Ser. No. 61/921,615 filed Dec. 30, 2013, the contents of which are incorporated herein by reference in its entirety.

### TECHNICAL FIELD

This document relates to mattresses, and more particularly, but not by way of limitation, to inflatable air mattress systems.

### SUMMARY

In one aspect, an air bed system includes a plurality of peripheral devices. The system further includes a pump unit configured to adjust a firmness of an air mattress, the pump unit includes a pump. The system further includes a controller configured to execute instructions that cause the pump unit to wirelessly pair with at least one of the plurality of peripheral devices. the pump unit is configured to: receive at least one control signal addressed to the at least one of the plurality of peripheral devices, and transmit the at least one control signal to the addressed device.

Implementations can include any, all, or none of the following features. The plurality of peripheral devices include a first peripheral device having a peripheral device controller configured to: receive the at least one control signal transmitted by the controller of the pump device; and control behavior of the associated peripheral device in accordance with the at least one control signal. The plurality of peripheral devices include an adjustable foundation having an adjustable foundation controller in communication with the controller of the pump unit to receive one or more control signals transmitted by the controller of the pump unit; and an air mattress pad having an air controller in communication with the controller of the pump unit to receive one or more control signals transmitted by the controller of the pump unit. The pump unit includes a pump unit housing containing the pump and the controller of the pump unit, wherein the air mattress includes an air chamber, wherein the pump is fluidically connected to the air chamber by an air hose extending from the pump unit housing to the air chamber, and wherein the plurality of peripheral devices are external to the pump unit housing and the air chamber. The plurality of peripheral devices are physically separated from the pump unit. The controller of the pump unit is configured to execute instructions that cause the pump unit to: form a wireless network with the plurality of peripheral devices, each of the peripheral devices including a peripheral device controller configured to 1) form the wireless network with the pump unit and 2) control behavior of the associated peripheral device in accordance with a control signal received from the pump device over the wireless network; and transmit at least one control signal to one of the plurality of peripheral device controllers over the wireless network. The pump unit device further includes an encasement that physically houses the pump and the controller. The instructions further cause the pump unit to: detect a new peripheral device including a peripheral device controller configured to 1) form the wireless network with the pump unit and 2) control behavior of the associated peripheral device in accordance with a control signal received from the pump device over the wireless network; and add the new peripheral device to the wireless network. The instructions further cause the pump unit to receive a data update configured to modify a user interface to include features specific to the new peripheral device. The instructions further cause the pump unit to receive a data update from the new peripheral device.

In one aspect, a method of operating a pump unit of an air bed system. The pump unit includes a pump and a controller, the method includes a method of operating a pump unit of an air bed system. The pump unit includes a pump and a controller. The method further includes adjusting firmness of an air mattress via the pump unit by driving the pump to modify air pressure in an air chamber of the air mattress. The method further includes executing instructions via the controller of the pump unit to cause the pump unit to wirelessly pair with at least one of a plurality of peripheral devices. The method further includes receiving via the controller of the pump unit at least one control signal addressed to the at least one of the plurality or peripheral devices. The method further includes transmitting via the controller of the pump unit the at least one control signal the at least one of the plurality of peripheral devices.

Implementations can include any, all, or none of the following features. The plurality of peripheral devices include a first peripheral device having a peripheral device controller, the method further including receiving by the peripheral device controller the at least one control signal transmitted by the controller of the pump device; and controlling behavior of the associated peripheral device by the peripheral device controller in accordance with the at least one control signal. The pump unit includes a pump unit housing containing the pump and the controller of the pump unit, wherein the pump is fluidically connected to the air chamber by an air hose extending from the pump unit housing to the air chamber, and wherein the plurality of peripheral devices are external to the pump unit housing and the air chamber. The method including forming a wireless network via the pump unit with the plurality of peripheral devices, each of the peripheral devices comprising a peripheral device controller configured to 1) form the wireless network with the pump unit and 2) control behavior of the associated peripheral device in accordance with a control signal received from the pump device over the wireless network; and transmitting at least one control signal via the pump unit to one of the plurality of peripheral device controllers over the wireless network. The method including detecting a new peripheral device via the controller of the pump unit; adding the new peripheral device to the wireless network via the controller of the pump unit; and receiving a data update via the controller of the pump unit to modify a user interface to include features specific to the new peripheral device, wherein the data update is optionally received from the new peripheral device.

In one aspect, a pump unit device includes a pump. The device further includes a controller configured to execute instructions that cause the pump unit to: form a wireless network with a plurality of peripheral devices, each of the peripheral devices includes a peripheral device controller configured to 1) form the wireless network with the pump unit and 2) control behavior of the associated peripheral device in accordance with a control signal received from the pump device over the wireless network. The device further includes transmit at least one control signal to one of the plurality of peripheral device controllers over the wireless network. a pump unit device includes a pump. The device further includes a controller configured to execute instructions that cause the pump unit to: form a wireless network with a plurality of peripheral devices, each of the peripheral devices includes a peripheral device controller configured to 1) form the wireless network with the pump unit and 2) control behavior of the associated peripheral device in accordance with a control signal received from the pump device over the wireless network. The device further includes transmit at least one control signal to one of the plurality of peripheral device controllers over the wireless network.

Implementations can include any, all, or none of the following features. The pump unit device further includes an encasement that physically houses the pump and the controller. The instructions further cause the pump unit to: detect a new peripheral device including a peripheral device controller configured to 1) form the wireless network with the pump unit and 2) control behavior of the associated peripheral device in accordance with a control signal received from the pump device over the wireless network; and add the new peripheral device to the wireless network. The instructions further cause the pump unit to receive a data update configured to modify a user interface to include features specific to the new peripheral device. The instructions further cause the pump unit to receive a data update from the new peripheral device.

### BRIEF DESCRIPTION OF DRAWINGS

Some embodiments are illustrated by way of example and not limitation in the figures of the accompanying drawings in which:

FIG. 1 is a block diagram of an example of an air bed system.

FIG. 2 is a block diagram of an example of an air bed system in accordance with various techniques of this disclosure.

FIG. 3 is a conceptual diagram depicting an example communications configuration between various components of an air bed system in accordance with various techniques of this disclosure.

FIG. 4 is a conceptual diagram depicting communications between a pump of an air bed system and various peripheral devices in accordance with this disclosure.

### DETAILED DESCRIPTION

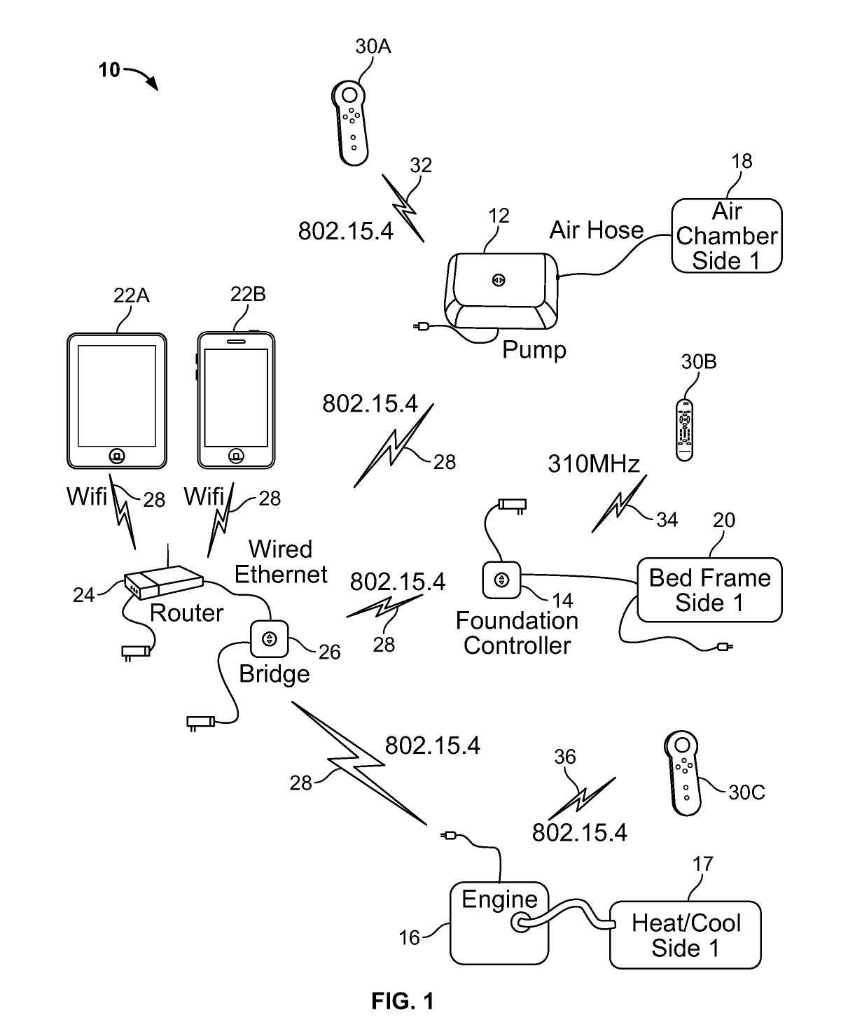

FIG. 1 is a block diagram of an example of an air bed system. In FIG. 1, the air bed system 10 may include a pump 12 having a controller (not depicted), a foundation controller 14 for controlling an adjustable foundation, and a thermoelectric engine 16 for heating/cooling air mattress pad 17. The pump 12 is configured to control the firmness of an air chamber, e.g., side 1 of an air chamber 18. The foundation controller 14 is configured to control the articulation of a bed frame, e.g., side 1 of a bed frame 20. It should be noted that for purposes of conciseness FIG. 1 depicts the pump 12, the foundation controller 14, and the thermoelectric engine 16 as controlling only one side, e.g., side 1, of the air bed system 10. In some example configurations, the pump 12, the foundation controller 14, and the thermoelectric engine 16 may each control two sides of an air bed system 10.

As depicted in FIG. 1, smart devices 22A, 22B (collectively referred to in this disclosure as “smart devices 22”), such as a smart phone and a tablet computer, may transmit control signals to one or more of the pump 12, the foundation controller 14, and the thermoelectric engine 16. In one specific configuration, the smart devices 22 may communicate via WiFi signals to a wireless router 24. The wireless router 24 may be connected, e.g., via a wired connection, to a bridge 26.

As seen in FIG. 1, the control signals 28 transmitted by the smart devices 22 may be received via the router 24 and then transmitted to one or more of the pump 12, the foundation controller 14, and the thermoelectric engine 16 by way of the bridge 26. In one specific example implementation, the bridge 26 may transmit the control signals 28 using a communication protocol such as IEEE 802.15.4 to one or more of the pump 12, the foundation controller 14, and the thermoelectric engine 16. A person of ordinary skill in the art will recognize that numerous other communication protocols may be used to transmit the control signals.

In addition to the smart devices 22, one or more remote controls may be used to transmit control signals to one or more of the pump 12, the foundation controller 14, and the thermoelectric engine 16. For example, a remote control 30A may transmit control signals 32 to the pump 12, a remote control 30B may transmit control signals 34 to the foundation controller 14, and a remote control 30C may transmit control signals 36 to the thermoelectric engine 16. The remote controls 30A, 30B, and 30C are collectively referred to in this disclosure as “remote controls 30.” The remote controls 30 may communicate using any number of communication techniques, including, for example, IEEE 802.15.4, radio frequency (RF), such as at 310 Megahertz (MHz), infrared, and the like.

As seen in the example configuration shown in FIG. 1, the control signals 28 from the smart devices 22 are transmitted from the bridge 26 to one or more of the pump 12, the foundation controller 14, and the thermoelectric engine 16. In some example configurations, the bridge 26 may broadcast the control signals to each of the pump 12, the foundation controller 14, and the thermoelectric engine 16, and then the relevant device(s), e.g., the pump 12, performs the requested function, e.g., increase the firmness of an air chamber, while the other devices, e.g., the foundation controller 14 and the thermoelectric engine 16, determine that the control signal is a pump-specific command and thus disregard the control signal.

In other example configurations, the bridge 26 may broadcast one or more device-specific control signals to one or more specific devices, e.g., the pump 12, which performs the requested function, e.g., increase firmness of an air chamber, while the other devices, e.g., the foundation controller 14 and the thermoelectric engine 16, do not receive the device-specific control signal.

Thus, in the system shown in FIG. 1, the control signals 28 may be transmitted from the bridge 26 to multiple devices, such as the pump 12, the foundation controller 14, and the thermoelectric engine 16. In this manner, the bridge 26 acts as a hub that distributes the control signals to the various devices of the air bed system. The bridge 26, however, is not part of the air bed system. In the system of FIG. 1, a device of the air bed system, e.g., the pump 12, is unaware of the state of the other devices of the system 10, e.g., the foundation controller 14 and the thermoelectric engine 16.

In contrast to the system 10 shown and described above with respect to FIG. 1 and in accordance with various techniques of this disclosure, one device of the air bed system, e.g., the pump 12, may act as a hub. For example, as described in more detail below, the pump 12 may receive all air bed related control signals from the smart devices 22 and then transmit the received control signals to the specific, relevant devices.

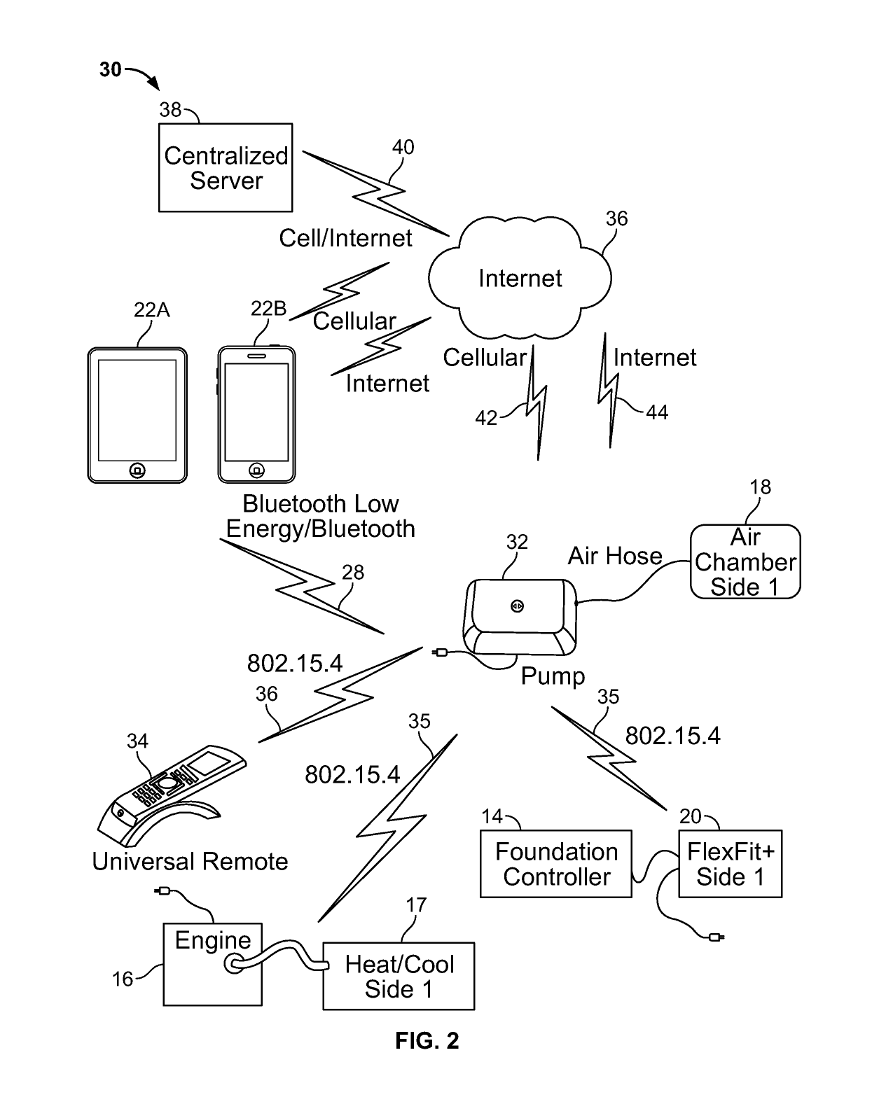

FIG. 2 is a block diagram of an example of an air bed system 30 in accordance with various techniques of this disclosure. Like in FIG. 1, the air bed system 30 in FIG. 2 may include a pump 32 having a controller (not depicted) (collectively a “pump unit”), a foundation controller 14, and a thermoelectric engine 16. In contrast to the system in FIG. 1, the smart devices 22 may communicate directly with the pump 32, rather than through the router 24 and the bridge 26 of FIG. 1. It should be noted that for purposes of conciseness, FIG. 2 depicts the pump 32, the foundation controller 14, and the thermoelectric engine 16 as controlling only one side, e.g., side 1, of the air bed system 30. In some example configurations, the pump 32, the foundation controller 14, and the thermoelectric engine 16 may each control two sides of an air bed system.

As seen in FIG. 2, the control signals 28 transmitted by the smart devices 22 may be received by a single device of the air bed system, e.g., the pump 32. Additionally or alternatively, the system may include a universal remote control 34 that may transmit the control signals 36 to the single device of the air bed system, e.g., the pump 32. Then, the single device, e.g., the pump 32, may act on the control signal if the control signal is designated for that device, e.g., a control signal to increase the firmness of an air chamber. If the control signal is not designated for that device, e.g., the pump 32, the device may transmit the control signal to another device of the air bed system, e.g., the foundation controller 14 or the thermoelectric engine 16, for which the control signal is designated. Thus, using the techniques of this disclosure, one device of the air bed system, e.g., the pump 32, may be aware of the state of each of the other devices of the air bed system.

For example, because the pump 32 receives all the control signals from the smart devices 22 and/or the universal remote control 34 and either acts upon or transmits those control signals to the various components of the air bed system, the pump 32 has state awareness of all the devices of the system. By way of specific example, a user may use the smart device 22 (or the universal remote control 34) to transmit control signals to increase the firmness of the air mattress and raise a head portion of the frame of the air bed system. The pump 32 receives the control signals and determines, e.g., via a controller in the pump (not depicted), that it (the pump 32) is the designated recipient of one of the control signals and acts accordingly to increase the firmness of the air mattress. After determining that the other control signal is designated for the foundation controller 14, the pump 32 transmits the control signal to the foundation controller 16. In response, the foundation controller 14 controls one or more articulation motors (not depicted) in order to raise the head portion of the frame. Because the pump 32 received both control signals, the pump 32 is aware of the position of the frame. In this manner, the pump has state awareness of all the devices of the system.

The control signals transmitted by the smart devices 22 and/or the universal remote control 34 to the pump 32 may use any one or more of numerous wireless communication standards, including, for example, Bluetooth, Bluetooth low energy (LE), Wi-Fi, cellular, IEEE 802.15, and the like. Similarly, the control signals 35 transmitted by the pump 32 to the various other components of the system may use any one or more of numerous wireless communication standard, including, for example, Bluetooth, Bluetooth LE, Wi-Fi, cellular, IEEE 802.15, and the like.

In some example implementations, the pump 32 may be connected to the Internet 36 in order to transmit/receive signals to/from a centralized server 38. For example, in order to ensure that a controller of the pump 32 includes the most recent firmware, the centralized server 38 may transmit a signal 40 over the Internet 36, requesting that the pump 32 transmit a signal that includes its firmware version. Alternatively, the centralized server 38 may transmit a signal over the Internet 36 that indicates the most recent firmware version. If the firmware version is not the most recent version, as determined by either the centralized server 38 or the pump 32, the centralized server 38 may transmit a control signal to the pump 32 that instructs the pump 32 to download the most recent firmware version or the centralized server 38 may transmit the most recent firmware version when the firmware and the pump 32 are available. The pump 32 may update its firmware and/or push the firmware to the universal remote control 34 for updating, e.g., to update a user interface on the remote control 34. The pump 32 and the centralized server 38 may be connected to the Internet 36 using a cellular connection 42 or a network connection 44, such as a wireless network connection or a wired network connection.

In addition, the system depicted in FIG. 2 may be used to perform diagnostics on one or more components of the system pump 32. For example, the pump 32 may determine that an error condition exists in one or more of the pump 32, the foundation controller 14, and the thermoelectric engine 16. The pump 32 may communicate the error condition to the centralized server 38 and the centralized server 38 may transmit signals including one or more instructions that, when executed by a controller of the pump 32, may then execute instructions in an attempt to correct the error condition.

It should be noted that the various functionalities ascribed to the pump 32 in this disclosure are achieved by the pump controller (which is not depicted for simplicity) executing instructions that are stored in a computer readable medium, for example.

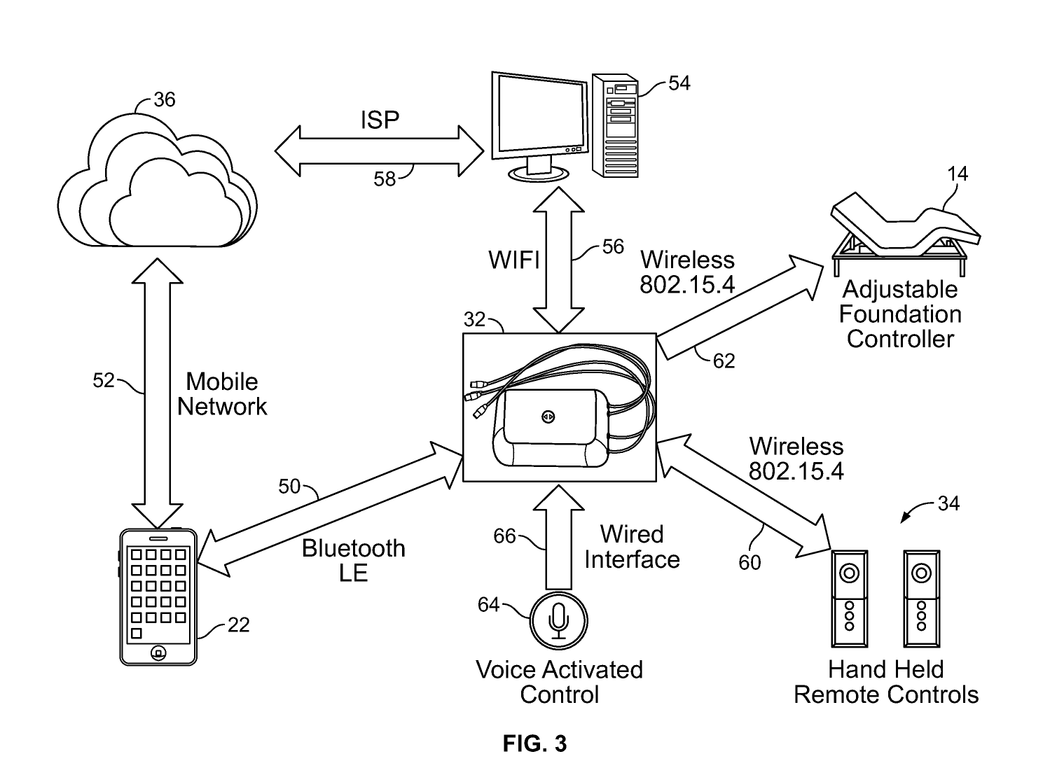

FIG. 3 is a conceptual diagram depicting an example communications configuration between various components of an air bed system. The non-limiting example configuration in FIG. 3 is for illustrative purposes only. In FIG. 3, the pump 32 may be connected to various air bed system components or other components using wireless or wired connection techniques.

For example, the smart device 22 may be wirelessly connected to the pump 32 via a Bluetooth connection 50, such as Bluetooth LE. In addition, the smart device 22 may be connected to the Internet 36 via a cellular connection 52 over a mobile communications network.

A computer 54, e.g., desktop or laptop computer, may communicate with the pump 32 via a wireless connection 56, e.g., Wi-Fi connection. In addition, the computer 54 may be connected to the Internet 36 by Internet Service Provider (ISP) 58. The computer 54 may be used to collect data from the components of the air bed system, e.g., the pump 32 and the adjustable foundation controller 14, and, in some examples, transmit the data over the Internet 36 for further analysis, e.g., by the centralized server 38 of FIG. 2.

One or more hand held universal remote controls 34 may be wirelessly connected to the pump 32 using IEEE 802.15.4, for example, as shown at 60. Similarly, the foundation controller 14 may be wirelessly connected to the pump 32 using IEEE 802.15.4, as shown at 62. Finally, the pump 32 may be controlled using voice activated control 64. The voice activated control 64 may be connected to the pump 32 using a wired interface 66.

The communication standards and protocols described above with respect to FIG. 3 are for illustrative purposes only. Those having ordinary skill in the art will understand upon reading this disclosure that numerous other standards and protocols may be used to implement various techniques of this disclosure.

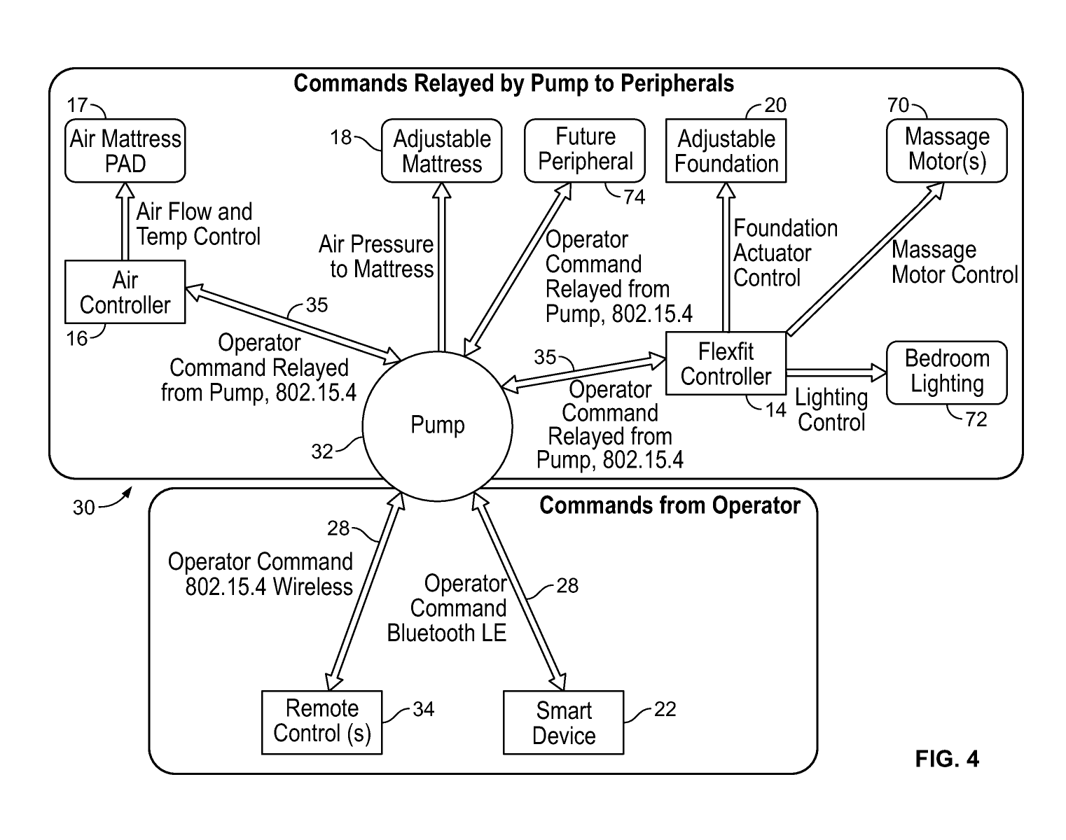

FIG. 4 is a conceptual diagram depicting communications between a pump of an air bed system and various peripheral devices, in accordance with this disclosure. As seen in FIG. 4, the pump 32 is a hub of the air bed system 30 with numerous peripherals in communication therewith. As described above, one or more users (or “operator”) may use a smart device 22 or remote control 34 to transmit control signals to the pump 32. For example, in FIG. 4, the smart device 22 may transmit control signals 28 wirelessly to the pump 32 using Bluetooth LE and the remote control 34 may transmit control signals wirelessly to the pump 32 using IEEE. 802.15.4.

In response to receiving the control signals 28 from the user, the pump 32 may act on the command, e.g., adjusting the air pressure to the adjustable air mattress 18, or transmit the control signal to one of the peripherals in the system. As seen in FIG. 4, the peripherals may include, but are not limited to, an air mattress pad 17, the adjustable foundation 20, a massage motor 70, and bedroom lighting 72.

In the example shown in FIG. 4, the flexfit or foundation controller 14 may control operation of the adjustable foundation 20, the massage motor 70, and the bedroom lighting 72 using wireless control signals 35 sent using IEEE 802.15.4, for example, from the pump 32. Similarly, the air controller or thermoelectric engine 16 may control operation of the air mattress pad 17 using wireless control signals 35 sent using IEEE 802.15.4, for example, from the pump 32.

In accordance with this disclosure and as shown in FIG. 4, one or more future peripherals 74 may be wirelessly controlled by the pump 32, e.g., using control signals sent using IEEE 802.15.4. Because the system peripherals and, in particular, the future peripherals 74, may wirelessly pair with the pump 32, the expandability of the air bed system is not constrained by any physical connectors. For example, the air bed system of this disclosure is not constrained by the number of connectors that may be mounted on the system hub, e.g., the pump 32. As such, future peripherals 74 may be easily added to the air bed system 30 by the user in an almost limitless fashion, constrained only by the number of bindings supported by the controller of the pump 32.

Future peripherals 74 include, but are not limited to, a home alarm system, home lighting, television(s), room shades, and room and/or home temperature. Upon acquiring a future peripheral 74, the user may pair the future peripheral 74 to the pump 32 and begin controlling that particular device, e.g., a television, using the control signals sent to the pump 32 from the smart device 22 or a universal remote control 34, for example. In this way, the air bed system 30 of this disclosure is designed for unknown, future peripherals to allow for seamless communication and expandability.

An ad-hoc pairing between a peripheral and the pump 32 may be created by automatically or manually binding at least two devices, e.g., a future peripheral such as a television and the pump 32. The creation of ad-hoc wireless networks is well known to those of ordinary skill in the art and, as such, need not be described in detail in this disclosure.

In addition, in some example configurations, the peripherals, e.g., the future peripherals, may include firmware to allow for automatic firmware updates upon binding with the pump 32. For example, upon manually or automatically binding with the pump 32, a new peripheral, e.g., a television, may transmit the new firmware to the remote control 34 through the pump 32 in order to update a user interface on the remote control 34. The updated user interface may include features specific to control of the new peripheral, e.g., the television. In this manner, the user can see the new user interface without having to purchase a new remote control 34 or a new pump 32. Additionally, such a configuration in which the new peripheral includes the new firmware for the remote control 34 and/or the pump 32, reduces or eliminates the need for the centralized server 38 of FIG. 2 to perform a full push of the firmware out to the pump 32 (and then to the remote control 34, for example).

In various examples, the controllers and devices described above, e.g., the controller of the pump 32, the foundation controller 14, the thermoelectric engine 16, may each include a processor, a storage device, and a network interface. The processor may be a general purpose central processing unit (CPU) or application-specific integrated circuit (ASIC). The storage device may include volatile or non-volatile static storage (e.g., Flash memory, RAM, EPROM, etc.). The storage device may store instructions which, when executed by the processor, configure the processor to perform the functionality described herein. For example, a processor of the foundation controller may be configured to send a command to a motor to adjust a position of the foundation.

In various examples, the network interface of the components may be configured to transmit and receive communications in a variety of wired and wireless protocols. For example, the network interface may be configured to use the 802.11 standards (e.g., 802.11a/b/c/g/n/ac), PAN network standards such as 802.15.4 or Bluetooth, infrared, cellular standards (e.g., 3G/4G etc.), Ethernet, and USB for receiving and transmitting data. The previous list is not intended to exhaustive and other protocols may be used. As shown and described above, not all components need to be configured to use the same protocols.

In various examples, the pump 32 is configured to analyze data collected by a pressure transducer to determine various states of a person lying on the bed. For example, the pump 32 may determine the heart rate or respiration rate of a person lying in the bed. Additional processing may be done using the collected data to determine a possible sleep state of the person. For example, the pump 32 may determine when a person falls asleep and, while asleep, the various sleep states of the person. Further, because the pump 32 acts a hub to the system and, as such, has state awareness of all of the peripheral devices, e.g., the foundation controller 14, a television, the thermoelectric engine 16, the pump may utilize the state information to analyze sleep data of the user. For example, the pump 32 (in particular the controller of the pump 32) may determine that a user achieves a desired sleep state more quickly if the adjustable foundation is in a particular position. The pump 32 may communicate this analysis to the computer 54, thereby allowing the user to react accordingly.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. As it common, the terms “a” and “an” may refer to one or more unless otherwise indicated.

What is claimed is:

1. An air bed system comprising:
a plurality of peripheral devices; and
a pump unit configured to adjust a firmness of an air mattress, the pump unit comprising:
a pump; and
a controller configured to execute instructions that cause the pump unit to wirelessly pair with at least one of the plurality of peripheral devices,
wherein the pump unit is configured to:
receive at least one control signal addressed to the at least one of the plurality of peripheral devices, and
transmit the at least one control signal to the addressed device.

2. The air bed system of claim 1, wherein the plurality of peripheral devices comprise a first peripheral device having a peripheral device controller configured to:
receive the at least one control signal transmitted by the controller of the pump device; and
control behavior of the associated peripheral device in accordance with the at least one control signal.

3. The air bed system of claim 1, wherein the plurality of peripheral devices comprise:
an adjustable foundation having an adjustable foundation controller in communication with the controller of the pump unit to receive one or more control signals transmitted by the controller of the pump unit; and
an air mattress pad having an air controller in communication with the controller of the pump unit to receive one or more control signals transmitted by the controller of the pump unit.

4. The air bed system of claim 1, wherein the pump unit comprises a pump unit housing containing the pump and the controller of the pump unit, wherein the air mattress comprises an air chamber, wherein the pump is fluidically connected to the air chamber by an air hose extending from the pump unit housing to the air chamber, and wherein the plurality of peripheral devices are external to the pump unit housing and the air chamber.

5. The air bed system of claim 1, wherein the plurality of peripheral devices are physically separated from the pump unit.

6. The air bed system of claim 1, wherein the controller of the pump unit is configured to execute instructions that cause the pump unit to:
form a wireless network with the plurality of peripheral devices, each of the peripheral devices comprising a peripheral device controller configured to 1) form the wireless network with the pump unit and 2) control behavior of the associated peripheral device in accordance with a control signal received from the pump device over the wireless network; and
transmit at least one control signal to one of the plurality of peripheral device controllers over the wireless network.

7. The air bed system of claim 6, wherein the pump unit device further comprises an encasement that physically houses the pump and the controller.

8. The air bed system of claim 6, wherein the instructions further cause the pump unit to:
detect a new peripheral device comprising a peripheral device controller configured to 1) form the wireless network with the pump unit and 2) control behavior of the associated peripheral device in accordance with a control signal received from the pump device over the wireless network; and
add the new peripheral device to the wireless network.

9. The air bed system of claim 6, wherein the instructions further cause the pump unit to receive a data update configured to modify a user interface to include features specific to the new peripheral device.

10. The air bed system of claim 6, wherein the instructions further cause the pump unit to receive a data update from the new peripheral device.

11. A method of operating a pump unit of an air bed system, wherein the pump unit comprises a pump and a controller, the method comprising:
adjusting firmness of an air mattress via the pump unit by driving the pump to modify air pressure in an air chamber of the air mattress;
executing instructions via the controller of the pump unit to cause the pump unit to wirelessly pair with at least one of a plurality of peripheral devices;
receiving via the controller of the pump unit at least one control signal addressed to the at least one of the plurality or peripheral devices; and
transmitting via the controller of the pump unit the at least one control signal the at least one of the plurality of peripheral devices.

12. The method of claim 11, wherein the plurality of peripheral devices comprise a first peripheral device having a peripheral device controller, the method further comprising:
receiving by the peripheral device controller the at least one control signal transmitted by the controller of the pump device; and
controlling behavior of the associated peripheral device by the peripheral device controller in accordance with the at least one control signal.

13. The method of claim 11, wherein the pump unit comprises a pump unit housing containing the pump and the controller of the pump unit, wherein the pump is fluidically connected to the air chamber by an air hose extending from the pump unit housing to the air chamber, and wherein the plurality of peripheral devices are external to the pump unit housing and the air chamber.

14. The method of claim 11, the method further comprising:
forming a wireless network via the pump unit with the plurality of peripheral devices, each of the peripheral devices comprising a peripheral device controller configured to 1) form the wireless network with the pump unit and 2) control behavior of the associated peripheral device in accordance with a control signal received from the pump device over the wireless network; and
transmitting at least one control signal via the pump unit to one of the plurality of peripheral device controllers over the wireless network.

15. The method of claim 14, the method further comprising:
detecting a new peripheral device via the controller of the pump unit;
adding the new peripheral device to the wireless network via the controller of the pump unit; and
receiving a data update via the controller of the pump unit to modify a user interface to include features specific to the new peripheral device, wherein the data update is received from the new peripheral device.

16. A pump unit device comprising:
a pump; and
a controller configured to execute instructions that cause the pump unit to:
form a wireless network with a plurality of peripheral devices, each of the peripheral devices comprising a peripheral device controller configured to 1) form the wireless network with the pump unit and 2) control behavior of the associated peripheral device in accordance with a control signal received from the pump device over the wireless network; and
transmit at least one control signal to one of the plurality of peripheral device controllers over the wireless network.

17. The pump unit device of claim 16, wherein the pump unit device further comprises an encasement that physically houses the pump and the controller.

18. The pump unit device of claim 16, wherein the instructions further cause the pump unit to:
detect a new peripheral device comprising a peripheral device controller configured to 1) form the wireless network with the pump unit and 2) control behavior of the associated peripheral device in accordance with a control signal received from the pump device over the wireless network; and
add the new peripheral device to the wireless network.

19. The pump unit device of claim 16, wherein the instructions further cause the pump unit to receive a data update configured to modify a user interface to include features specific to the new peripheral device.

20. The pump unit device of claim 16, wherein the instructions further cause the pump unit to receive a data update from the new peripheral device.
